(19) United States
(12) Patent Application Publication
(10) Pub. No.: US 2024/0079813 A1
(43) Pub. Date: Mar. 7, 2024

(54) Connector Housing, Connector and Connector Assembly

(71) Applicant: Tyco Electronics (Shanghai) Co., Ltd., Shanghai (CN)

(72) Inventors: Siqi (Celina) Chen, Shanghai (CN); Jianghua (Gary) Zhu, Suzhou (CN); Jun Zong, Shanghai (CN)

(73) Assignee: Tyco Electronics (Shanghai) Co., Ltd., Shanghai (CN)

(21) Appl. No.: 18/242,247

(22) Filed: Sep. 5, 2023

(30) Foreign Application Priority Data
Sep. 6, 2022 (CN) 202222363881.6

(51) Int. Cl. H01R 13/436; H01R 13/514; H01R 13/639

(52) U.S. Cl. CPC H01R 13/4364; H01R 13/514; H01R 13/639

(57) ABSTRACT

A connector housing includes a housing body and a first buckle device formed on a side of the housing body and inserted into a first accommodating cavity of a first mating buckle device of a mating connector housing. The first buckle device includes a first elastic buckle. The first elastic buckle has an elastic cantilever, a retaining protrusion formed on a free end of the elastic cantilever and engaging with a pre locking slot on a side wall of the first accommodating cavity, and a blocking part resting against an inner wall surface of the side wall of the first accommodating cavity when the retaining protrusion is engaged with the pre locking slot. The blocking part limits the elastic cantilever within the first accommodating cavity.

### CROSS-REFERENCE TO RELATED APPLICATION

This application claims the benefit of the filing date under 35 U.S.C. § 119(a)-(d) of Chinese Patent Application No. 202222363881.6, filed on Sep. 6, 2022.

### FIELD OF THE INVENTION

The present invention relates to a connector housing, a connector including the connector housing, and a connector assembly including the connector.

### BACKGROUND

A high-voltage interlocking connector typically includes a male and female connector suitable for mating. For safety reasons, it is desirable that the male and female connectors cannot be accidentally mated together, as once the male and female connectors are accidentally mated together, it can cause high voltage electrification, which is very dangerous and can lead to safety issues. For example, when workers are repairing connections, accidental mating can cause hazards such as electric shock.

In order to facilitate assembly, the male connector can be moved between the pre lock position and the final lock position relative to the female connector. When the male and female connectors are in the pre lock position, there is no electrical contact between the terminals of the male and female connectors. When the male and female connectors are in the final lock position, the terminals of the male and female connectors are in electrical contact with each other. Therefore, in order to prevent accidental mating of male and female connectors to the final lock position, it is necessary to reliably maintain the male and female connectors in the pre lock position.

An elastic buckle is commonly arranged on the male connector housing and a pre locking slot is formed on the female connector housing. The elastic buckle is engaged in the pre locking slot, thereby reliably maintaining the male and female connectors in the pre lock position. If the male and female connectors need to continue mating to the final lock position, it is necessary to first separate the elastic buckle from the pre locking slot. However, in practical applications, the male connector may be pushed without separating the elastic buckle from the pre locking slot, which can cause the elastic buckle to be moved outward. When the elastic buckle is moved outward too much, the elastic buckle is damaged and potentially broken.

### SUMMARY

A connector housing includes a housing body and a first buckle device formed on a side of the housing body and inserted into a first accommodating cavity of a first mating buckle device of a mating connector housing. The first buckle device includes a first elastic buckle. The first elastic buckle has an elastic cantilever, a retaining protrusion formed on a free end of the elastic cantilever and engaging with a pre locking slot on a side wall of the first accommodating cavity, and a blocking part resting against an inner wall surface of the side wall of the first accommodating cavity when the retaining protrusion is engaged with the pre locking slot. The blocking part limits the elastic cantilever within the first accommodating cavity.

### BRIEF DESCRIPTION OF THE DRAWINGS

Features of the present invention will become more apparent by describing in detail exemplary embodiments thereof with reference to the accompanying drawings, in which:

FIG. 1 shows an illustrative exploded view of a connector and a mating connector according to an exemplary embodiment of the present invention when viewed from one side;

FIG. 2 shows an illustrative perspective view of a connector housing and a safety device according to an exemplary embodiment of the present invention;

FIG. 3 shows an illustrative exploded view of a connector and a mating connector according to an exemplary embodiment of the present invention when viewed from the other side;

FIG. 4 shows a cross-sectional view of a connector and a mating connector according to an exemplary embodiment of the present invention, wherein the connector and mating connector are in a separate state;

FIG. 5 shows a cross-sectional view of a connector and a mating connector according to an exemplary embodiment of the present invention, wherein the connector and mating connector are in a pre lock position;

FIG. 6 shows a cross-sectional view of a connector and a mating connector according to an exemplary embodiment of the present invention, wherein the connector and mating connector are in a final lock position;

FIG. 7 shows a cross-sectional view of a connector and a mating connector according to an exemplary embodiment of the present invention, wherein the connector and mating connector are in the final lock position and the safety device is shown;

FIG. 8 shows another cross-sectional view of the connector and mating connector according to an exemplary embodiment of the present invention, wherein the connector and mating connector are in the final lock position and the safety device is shown;

FIG. 9 shows an illustrative exploded view of the connector and mating connector according to another exemplary embodiment of the present invention; and

FIG. 10 shows a cross-sectional view of a connector and a mating connector according to another exemplary embodiment of the present invention, wherein the connector and mating connector are in the pre lock position.

### DETAILED DESCRIPTION OF EXEMPLARY EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

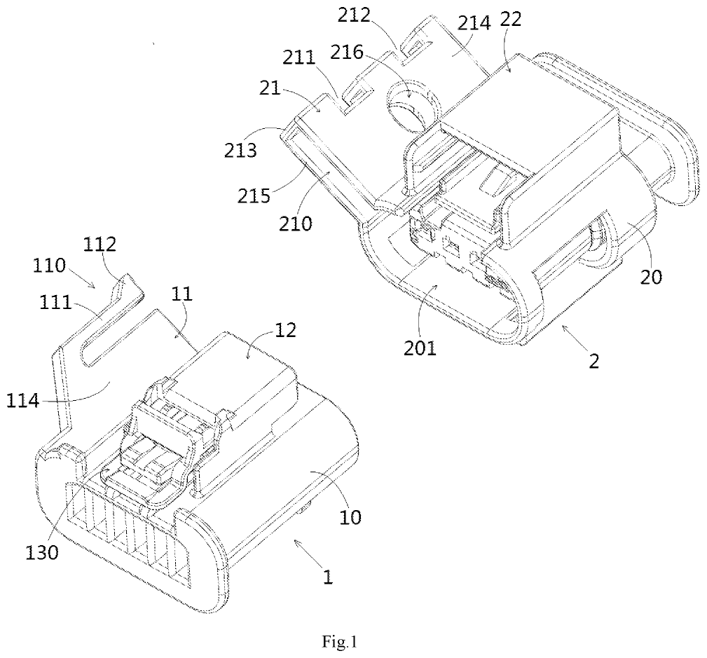

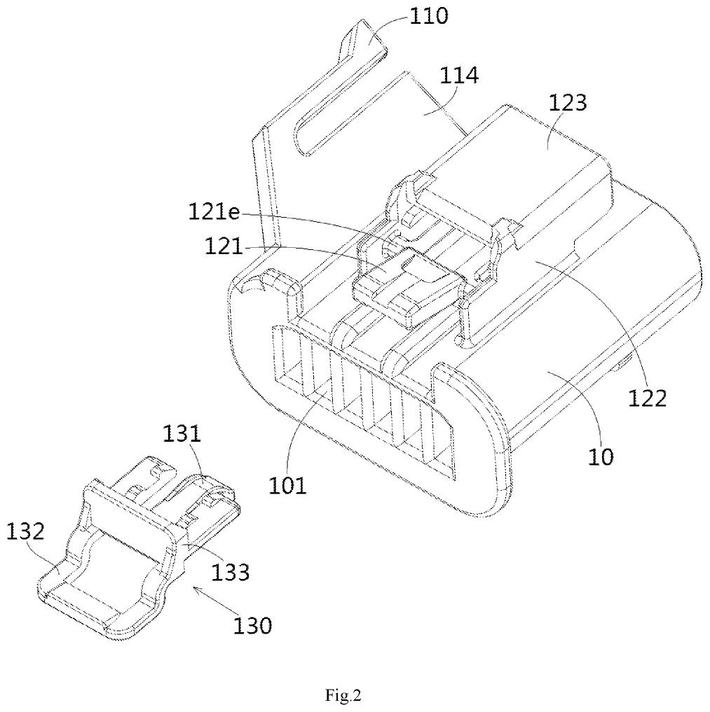

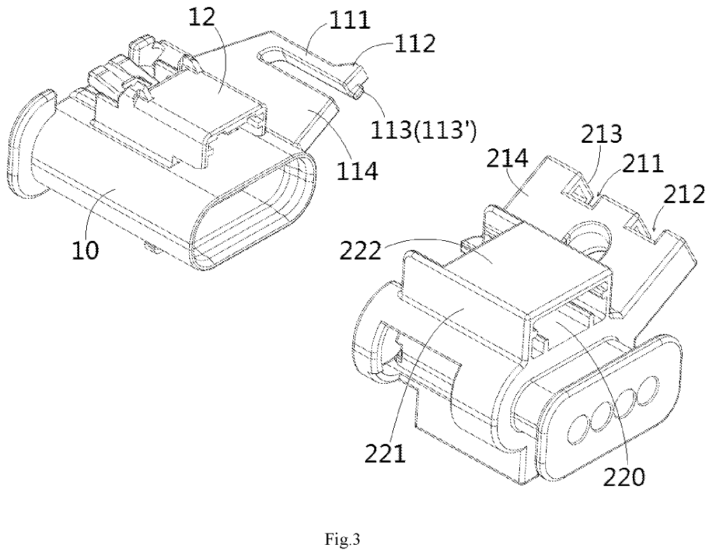

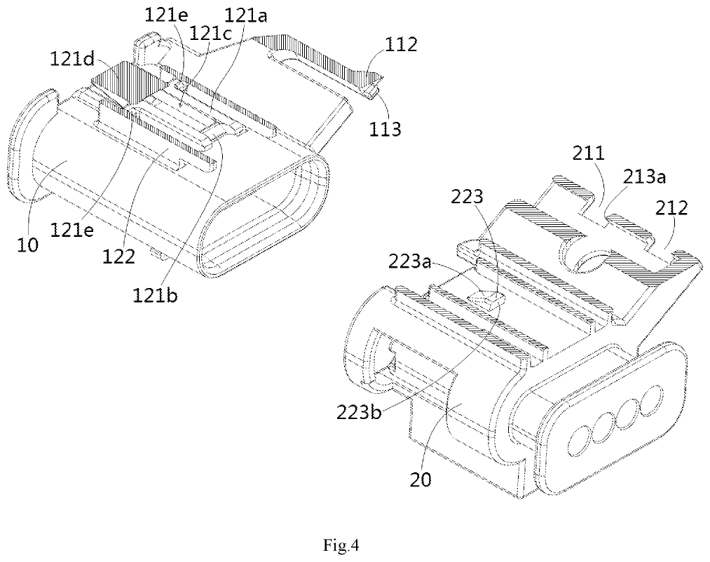

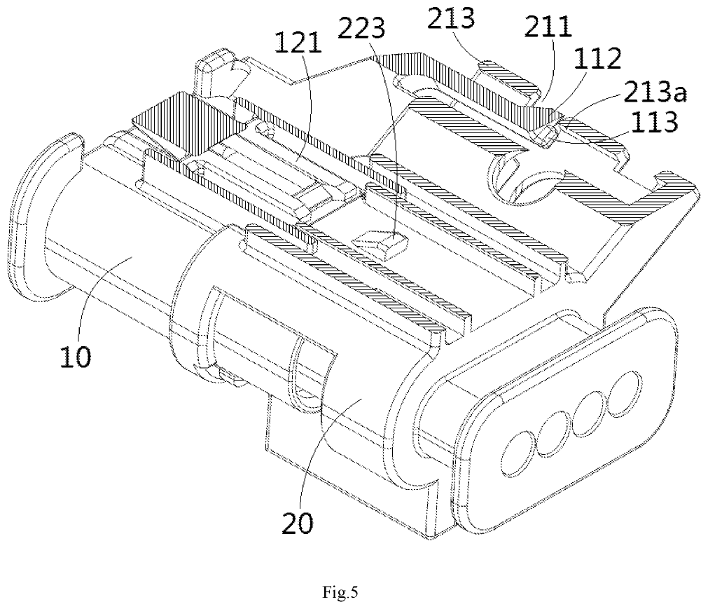

FIG. 1 shows an illustrative exploded view of a connector and a mating connector according to an exemplary embodiment of the present invention when viewed from one side. FIG. 2 shows an illustrative perspective view of the connector housing 1 and the safety device 130 according to an exemplary embodiment of the present invention. FIG. 3 shows an illustrative exploded view of a connector and a mating connector according to an exemplary embodiment of the present invention when viewed from the other side. FIG. 4 shows a cross-sectional view of a connector and a mating connector according to an exemplary embodiment of the present invention, with the connector and mating connector in a separated state. FIG. 5 shows a cross-sectional view of a connector and a mating connector according to an exemplary embodiment of the present invention, with the connector and mating connector are in a pre lock position.

As shown in FIGS. 1 to 5, in an exemplary embodiment of the present invention, a connector housing 1 includes a housing body 10 and a first buckle device 11. The first buckle device 11 is formed on the side of the housing body 10 and is suitable for insertion into the first accommodating cavity 210 of the first mating buckle device 21 of the mating connector housing 2. The first buckle device 11 includes a first elastic buckle 110. The first elastic buckle 110 includes an elastic cantilever 111, a retaining protrusion 112, and a blocking part 113.

The retaining protrusion 112 is formed on the free end of the elastic cantilever 111 and is suitable for engagement with the pre locking slot 211 on the side wall 213 of the first accommodating cavity 210. The blocking part 113 is adapted to rest against the inner wall surface 213a of the side wall 213 of the first accommodating cavity 210 when the retaining protrusion 112 is engaged with the pre locking slot 211, in order to prevent the elastic cantilever 111 from being moved outward relative to the side wall 213 of the first accommodating cavity 210. In this way, it is possible to prevent the free end of the elastic cantilever 111 from being broken due to excessive outward movement.

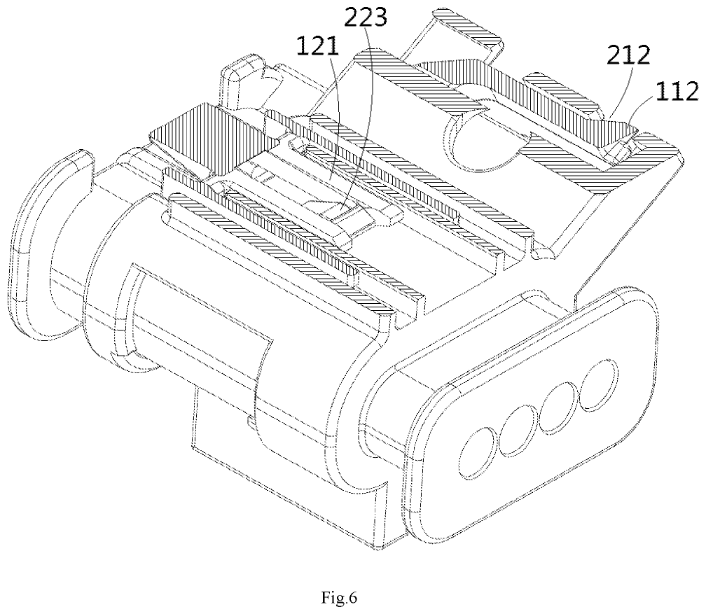

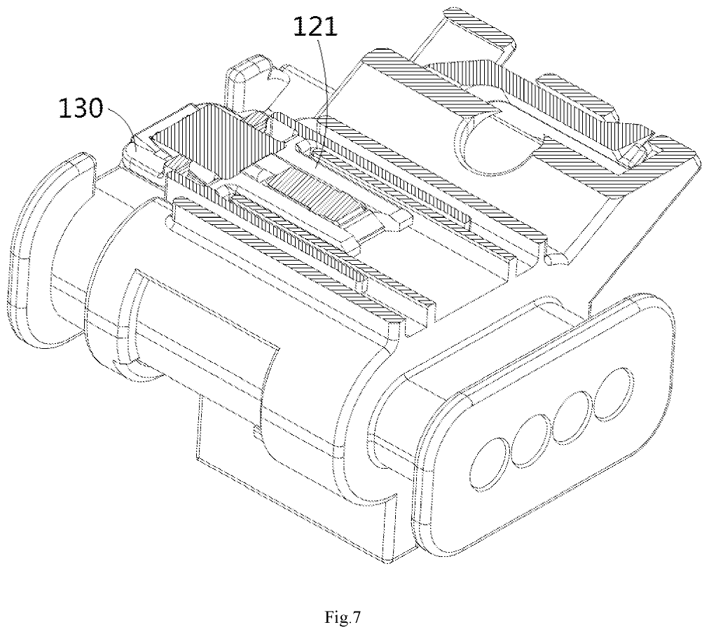

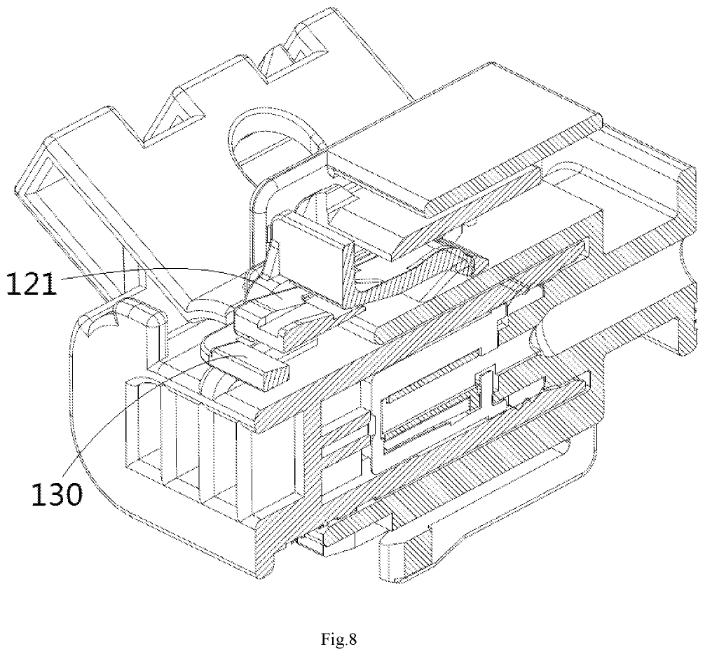

FIG. 6 shows a cross-sectional view of a connector and a mating connector according to an exemplary embodiment of the present invention, with the connector and mating connector in the final lock position. FIG. 7 shows a cross-sectional view of a connector and a mating connector according to an exemplary embodiment of the present invention, with the connector and mating connector in the final lock position and showing a safety device 130. FIG. 8 shows another cross-sectional view of the connector and mating connector according to an exemplary embodiment of the present invention, with the connector and mating connector in the final lock position and with the safety device 130.

As shown in FIGS. 1 to 3, in the illustrated embodiment, the first buckle device 11 further includes a side wing part 114, which is connected to one side of the housing body 10. The fixed end of the elastic cantilever 111 is connected to the side wing part 114, and the elastic cantilever 111 extends along the longitudinal direction of the housing body 10. The retaining protrusion 112 protrudes outward along a transverse direction perpendicular to the longitudinal direction of the housing body 10. The blocking part 113 is formed on an end face of the retaining protrusion 112 and protrudes forward along the longitudinal direction of the housing body 10 from the end face of the retaining protrusion 112.

As shown in FIGS. 1 to 3, in the illustrated embodiment, the connector housing 1 further includes a second buckle device 12. The second buckle device 12 is formed on the top of the housing body 10 and is suitable for insertion into the second accommodating cavity 220 of the second mating buckle device 22 of the mating connector housing. The second buckle device 12 includes a second elastic buckle 121. The second elastic buckle 121 engages with the final lock protrusion 223 on the inner wall surface of the second accommodating cavity 220. When the retaining protrusion 112 is engaged with the final locking slot 212 on the side wall 213 of the first accommodating cavity 210, the second elastic buckle 121 engages with the final lock protrusion 223 to hold the connector housing 1 and the mating connector housing 2 in the final lock position.

As shown in FIG. 2, in the illustrated embodiment, the second buckle device 12 further includes a pair of support walls 122 formed on the housing body 10 and a top wall 123 connected between the tops of the pair of support walls 122. The pair of support walls 122 and top wall 123 define an accommodation space. the second elastic buckle 121 is provided in the accommodation space and is connected to the pair of support walls 122.

As shown in FIG. 4, in the illustrated embodiment, the second elastic buckle 121 includes a pressing part 121d, a pair of longitudinal beams 121a, and a crossbeam 121b. The rear ends of the pair of longitudinal beams 121a are connected to the pressing part 121d. The crossbeam 121b is connected between the front ends of the pair of longitudinal beams 121a. The rear end of each of the pair of longitudinal beams 121a is formed with an elastic connection part 121e. The elastic connection part 121e is connected to the support wall 122, so that the second elastic buckle 121 can be moved to an unlocking position separated from the final lock protrusion 223 by pressing the pressing part 121d.

As shown in FIG. 4, in the illustrated embodiment, a hollow accommodating part 121c is defined and surrounded by the pair of longitudinal beams 121a, the crossbeam 121b, and the pressing part 121d. When the second elastic buckle 121 engages with the final lock protrusion 223, the final lock protrusion 223 enters the accommodating part 121c and rests against the crossbeam 121b.

As shown in FIGS. 1 and 2, in the illustrated embodiment, the connector housing 1 further includes a safety device 130, which is inserted into the second buckle device 12 to prevent the second elastic buckle 121 from being moved to the unlocking position separate from the final lock protrusion 223.

As shown in FIG. 2, in the illustrated embodiment, the safety device 130 includes: an operation part 133, an insertion part 132, and a cantilever part 131. The safety device 130 can be inserted into the second buckle device 12 by grasping the operation part 133. The insertion portion 132 extends backwards from the operation portion 133 and is adapted to be inserted below the pressing part 121d to prevent the pressing part 121d from being pressed downward. The cantilever part 131 extends forward from the operation portion 133 to engage in the accommodating part 121c to prevent the safety device 130 from falling off.

In another exemplary embodiment of the present invention, a connector is also disclosed. The connector includes: a connector housing 1 and a terminal. The terminal is arranged in a terminal slot 101 of the connector housing 1 for mating connection with the mating terminal in the mating connector.

In another exemplary embodiment of the present invention, a connector assembly is also disclosed. The connector assembly includes: a connector and a mating connector. The connector is mated with the mating connector. The mating connector includes a mating connector housing 2, shown in FIG. 1, which is mated with the connector housing 1 and a mating terminal arranged in the mating connector housing 2. The mating connector housing 2 includes a mating housing body 20 and a first mating buckle device 21. The housing body 20 has an inner cavity 201. The housing body 10 is suitable for insertion into the inner cavity 201 of the mating housing body 20. The first mating buckle device 21 is formed on the side of the mating housing body 20 and includes a top wall 214, a bottom wall 215, and a side wall 213. A first accommodating cavity 210 is defined and surrounded by the top wall 214, the bottom wall 215, and the side wall 213. A pre locking slot 211 and a final locking slot 212 are formed on the side wall 213 of the first accommodating cavity 210. The pre locking slot 211 and the final locking slot 212 are spaced at a predetermined distance in the longitudinal direction of the mating housing body 20. The inner cavity 201 of the mating housing body 20 is communicated with the first accommodating cavity 210 of the first mating buckle device 21, and the housing body 10 and the first buckle device 11 are respectively inserted into the inner cavity 201 of the mating housing body 20 and the first accommodating cavity 210 of the first mating buckle device 21.

When the connector and the mating connector are assembled to the pre lock position, the pre locking slot 211 engages with the retaining protrusion 112 on the connector housing 1 to hold the connector and the mating connector in the pre lock position. When the connector and the mating connector are assembled to the final lock position, the final locking slot 212 engages with the retaining protrusion 112 on the connector housing 1 to hold the connector and the mating connector in the final lock position.

As shown in FIG. 1, in the illustrated embodiment, the mating connector housing 2 also includes a second mating buckle device 22, which is formed on the top of the mating housing body 20 and, as shown in FIG. 3, includes a pair of side plates 221 and a top plate 222. A second accommodating cavity 220 is defined and surrounded by the pair of side plates 221 and the top plate 222. A final lock protrusion 223 is formed on the inner wall surface of the bottom wall of the second accommodating cavity 220. When the connector and the mating connector are assembled to the final lock position, the final lock protrusion 223 engages with the second elastic buckle 121 on the connector housing 1 to hold the connector and the mating connector in the final lock position.

As shown in FIG. 4, in the illustrated embodiment, the final lock protrusion 223 has a rear side surface 223a and a front side surface 223b. The rear side surface 223a of the final lock protrusion 223 is inclined to the longitudinal direction of the mating housing body 20, used to guide the final lock protrusion 223 into the accommodating part 121c of the second elastic buckle 121. The front side surface 223b of the final lock protrusion 223 is perpendicular to the longitudinal direction of the mating housing body 20 and is used to rest against the crossbeam 121b of the second elastic buckle 121.

As shown in FIG. 1, in the illustrated embodiment, a padlock hole 216 is formed in the top wall 214 and bottom wall 215 of the first accommodating cavity 210. The padlock can be locked into the padlock hole 216. In the illustrated embodiment, when the connector and the mating connector are assembled to the pre lock position, the side wing part 114 on the connector housing 1 is blocked by the padlock locked in the padlock hole 216 to prevent the connector and the mating connector from being further assembled to the final lock position. In this way, it can reliably prevent the connector and the mating connector from being accidentally assembled to the final lock position, improving the safety performance of the product.

When the connector and the mating connector are assembled to the pre lock position, the terminal of the connector and the mating terminal of the mating connector are in a non-contact electrical separation state. When the connector and the mating connector are assembled to the final lock position, the terminal of the connector and the mating terminal of the mating connector are electrically connected in contact with each other.

In the embodiments shown in FIGS. 3 and 4, the blocking part 113 is formed on the end face of the retaining protrusion 112 and protrudes forward along the longitudinal direction of the housing body 10 from the end face of the retaining protrusion 112.

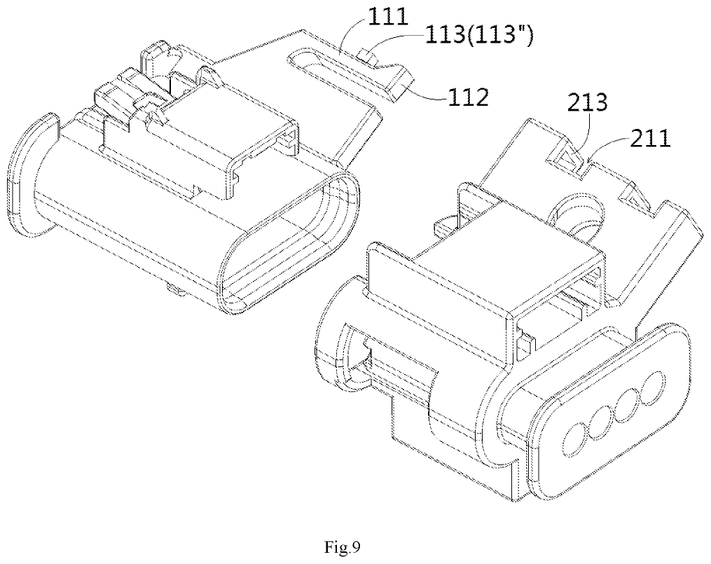

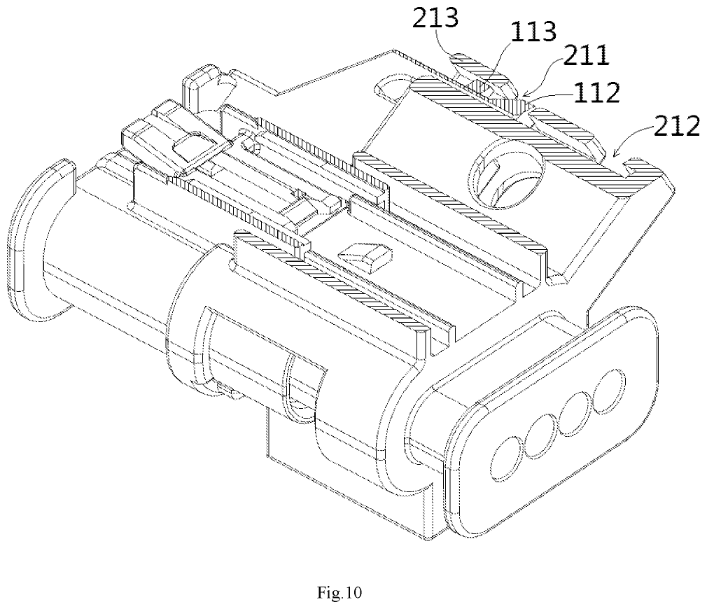

The present invention is not limited to the aforementioned embodiments. For example, FIGS. 9 and 10 show another exemplary embodiment according to the present invention. Among them, FIG. 9 shows an illustrative exploded view of the connector and mating connector according to another exemplary embodiment of the present invention; FIG. 10 shows a cross-sectional view of a connector and a mating connector according to another exemplary embodiment of the present invention, wherein the connector and mating connector are in a pre lock position.

As shown in FIGS. 9 and 10, in the illustrated embodiment, the retaining protrusion 112 protrudes outward along a transverse direction perpendicular to the longitudinal direction of the housing body 10. The blocking part 113 is formed on a side of the elastic cantilever 111 and protrudes from the side of the elastic cantilever 111 along the transverse direction of the housing body 10 towards the side wall 213 of the first accommodating cavity 210.

As shown in FIGS. 9 and 10, in the illustrated embodiments, when the retaining protrusion 112 is engaged with the pre locking slot 211, the blocking part 113 rests against the inner wall surface 213a of the side wall 213 of the first accommodating cavity 210 to prevent the elastic cantilever 111 from being moved outward relative to the side wall 213 of the first accommodating cavity 210. In this way, it can also prevent the free end of the elastic cantilever 111 from being broken due to excessive outward movement.

In another exemplary embodiment of the present invention, the blocking part 113 may include a first blocking part 113′ (see FIG. 3) and a second blocking part 113″ (see FIG. 9). The first blocking part 113′ is formed on the end face of the retaining protrusion 112 and protrudes forward along the longitudinal direction of the housing body 10 from the end face of the retaining protrusion 112. The second blocking part 113″ is formed on the side of the elastic cantilever 111 and protrudes from the side of the elastic cantilever 111 along the transverse direction of the housing body 10 towards the side wall 213 of the first accommodating cavity 210. In this way, the blocking force that blocks the outward movement of the elastic cantilever 111 can be increased, thereby more effectively preventing the outward movement of the elastic cantilever 111.

In the aforementioned exemplary embodiments of the present invention, the blocking part can reliably prevent the first elastic buckle from being moved outward, thereby preventing damage to the first elastic buckle due to excessive outward movement.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector housing, comprising:
a housing body; and
a first buckle device formed on a side of the housing body and inserted into a first accommodating cavity of a first mating buckle device of a mating connector housing, the first buckle device includes a first elastic buckle, the first elastic buckle has an elastic cantilever, a retaining protrusion formed on a free end of the elastic cantilever and engaging with a pre locking slot on a side wall of the first accommodating cavity, and a blocking part resting against an inner wall surface of the side wall of the first accommodating cavity when the retaining protrusion is engaged with the pre locking slot, the blocking part limiting the elastic cantilever within the first accommodating cavity.

2. The connector housing according to claim 1, wherein the first buckle device includes a side wing part connected to a side of the housing body, a fixed end of the elastic cantilever is connected to the side wing part, and the elastic cantilever extends along a longitudinal direction of the housing body.

3. The connector housing according to claim 2, wherein the retaining protrusion protrudes outward along a transverse direction perpendicular to the longitudinal direction of the housing body, the blocking part is formed on an end face of the retaining protrusion and protrudes forward along the longitudinal direction of the housing body from the end face of the retaining protrusion.

4. The connector housing according to claim 2, wherein the retaining protrusion protrudes outward along a transverse direction perpendicular to the longitudinal direction of the housing body, the blocking part is formed on a side of the elastic cantilever and protrudes from the side of the elastic cantilever along the transverse direction of the housing body towards the side wall of the first accommodating cavity.

5. The connector housing according to claim 2, wherein the retaining protrusion protrudes outward along a transverse direction perpendicular to the longitudinal direction of the housing body, the blocking part includes:
a first blocking part formed on an end face of the retaining protrusion and protruding forward along the longitudinal direction of the housing body from the end face of the retaining protrusion; and
a second blocking part formed on a side of the elastic cantilever and protruding from the side of the elastic cantilever along the transverse direction of the housing body towards the side wall of the first accommodating cavity.

6. The connector housing according to claim 1, further comprising a second buckle device formed on a top of the housing body and inserted into a second accommodating cavity of a second mating buckle device of the mating connector housing.

7. The connector housing according to claim 6, wherein the second buckle device includes a second elastic buckle engaging with a final lock protrusion on an inner wall surface of the second accommodating cavity, and when the retaining protrusion engages with a final locking slot on the side wall of the first accommodating cavity, the second elastic buckle engages with the final lock protrusion to hold the connector housing and the mating connector housing in a final lock position.

8. The connector housing according to claim 7, wherein the second buckle device includes a pair of support walls formed on the housing body and a top wall connected between a pair of tops of the pair of support walls, an accommodation space is defined by the pair of support walls and the top wall, the second elastic buckle is arranged in the accommodation space and connected to the pair of support walls.

9. The connector housing according to claim 8, wherein the second elastic buckle includes a pressing part, a pair of longitudinal beams having a pair of rear ends connected to the pressing part, and a crossbeam connected between a pair of front ends of the pair of longitudinal beams.

10. The connector housing according to claim 9, wherein the rear ends of each of the pair of longitudinal beams have an elastic connection part connected to one of the support walls, the second elastic buckle can be moved to an unlocking position separated from the final lock protrusion by pressing the pressing part, an accommodating part is defined by the pair of longitudinal beams, the crossbeam, and the pressing part, and when the second elastic buckle engages with the final lock protrusion, the final lock protrusion enters the accommodating part and rests against the crossbeam.

11. The connector housing according to claim 10, further comprising a safety device inserted into the second buckle device to prevent the second elastic buckle from being moved to the unlocking position separate from the final lock protrusion, the safety device includes an operation part for inserting the safety device into the second buckle device, an insertion part extending backwards from the operation part and inserted below the pressing part to prevent the pressing part from being pressed downward, and a cantilever part extending forward from the operation part and engaged into the accommodating part to prevent the safety device from falling off.

12. A connector, comprising:
a connector housing including a housing body and a first buckle device formed on a side of the housing body and inserted into a first accommodating cavity of a first mating buckle device of a mating connector housing, the first buckle device includes a first elastic buckle, the first elastic buckle has an elastic cantilever, a retaining protrusion formed on a free end of the elastic cantilever and engaging with a pre locking slot on a side wall of the first accommodating cavity, and a blocking part resting against an inner wall surface of the side wall of the first accommodating cavity when the retaining protrusion is engaged with the pre locking slot, the blocking part limiting the elastic cantilever within the first accommodating cavity; and
a terminal provided in the connector housing and matable with a mating terminal of a mating connector.

13. A connector assembly, comprising:
a connector including:
a connector housing including a housing body and a first buckle device formed on a side of the housing body, the first buckle device includes a first elastic buckle, the first elastic buckle has an elastic cantilever, a retaining protrusion formed on a free end of the elastic cantilever and engaging with a pre locking slot on a side wall of the first accommodating cavity, and a blocking part resting against an inner wall surface of the side wall of the first accommodating cavity when the retaining protrusion is engaged with the pre locking slot, the blocking part limiting the elastic cantilever within the first accommodating cavity; and
a terminal provided in the connector housing; and
a mating connector mated with the connector, the mating connector includes a mating connector housing mated with the connector housing and a mating terminal arranged in the mating connector housing.

14. The connector assembly according to claim 13, wherein the mating connector housing includes a mating housing body having an inner cavity and a first mating buckle device formed on a side of the mating housing body and including a top wall, a bottom wall, and a side wall.

15. The connector assembly according to claim 14, wherein the first mating buckle device is formed with a first accommodating cavity surrounded by the top wall, the bottom wall and the side wall, a pre locking slot and a final locking slot are formed on the side wall of the first accommodating cavity, and the pre locking slot and the final locking slot are spaced at a predetermined distance in a longitudinal direction of the mating housing body, the pre locking slot engages with the retaining protrusion on the connector housing to hold the connector and the mating connector in a pre lock position when the connector and the mating connector are assembled to the pre lock position, the final locking slot engages with the retaining protrusion on the connector housing to hold the connector and the mating connector in a final lock position when the connector and the mating connector are assembled to the final lock position.

16. The connector assembly according to claim 15, wherein the inner cavity of the mating housing body communicates with the first accommodating cavity of the first mating buckle device, the housing body and the first buckle device are respectively inserted into the inner cavity of the mating housing body and the first accommodating cavity of the first mating buckle device.

17. The connector assembly according to claim 15, wherein a padlock hole is formed in the top wall and bottom wall of the first accommodating cavity, a side wing part on the connector housing is blocked by a padlock locked in the padlock hole to prevent the connector and the mating connector from being further assembled to the final lock position when the connector and the mating connector are assembled to the pre lock position.

18. The connector assembly according to claim 15, wherein the mating connector housing includes a second mating buckle device formed on a top of the mating housing body and including a pair of side plates and a top plate, the second mating buckle device has a second accommodating cavity surrounded by the pair of side plates and the top plate, and a final lock protrusion is formed on an inner wall surface of the bottom wall of the second accommodating cavity, a final lock protrusion engages with a second elastic buckle on the connector housing to hold the connector and the mating connector in the final lock position.

19. The connector assembly according to claim 18, wherein the final lock protrusion includes:
a rear side surface which is inclined to the longitudinal direction of the mating housing body and is guides the final lock protrusion into an accommodating part of the second elastic buckle; and
a front side surface perpendicular to the longitudinal direction of the mating housing body and resting against a crossbeam of the second elastic buckle.

20. The connector assembly according to claim 13, wherein, when the connector and the mating connector are assembled to a pre lock position, the terminal of the connector is separated from the mating terminal of the mating connector, and when the connector and the mating connector are assembled to a final lock position, the terminal of the connector is in electrical contact with the mating terminal of the mating connector.
